(19) United States
(12) Patent Application Publication
(10) Pub. No.: US 2020/0149390 A1
(43) Pub. Date: May 14, 2020

(54) METHOD AND APPARATUS FOR PERFORMING A SURVEY OF TUBING WHICH IS STUCK IN A BOREHOLE, E.G. FOR DETERMINING A FREE POINT

(71) Applicant: Altus Intervention (Technologies) AS, Stavanger (NO)

(72) Inventors: Darrell S. Sonne, Katy, TX (US); Olav Lindtjorn, Katy, TX (US)

(73) Assignee: Altus Intervention (Technologies) AS, Stavanger (NO)

(21) Appl. No.: 16/615,467

(22) PCT Filed: May 23, 2018
(86) PCT No.: PCT/NO2018/050133

§ 371 Date: Nov. 21, 2019

(30) Foreign Application Priority Data
May 23, 2017 (NO) 20170852

(51) Int. Cl. E21B 47/09; G01V 11/00; E21B 47/12; E21B 31/107; E21B 29/00

(52) U.S. Cl. CPC E21B 47/091; G01V 11/005; E21B 2023/008; E21B 31/107; E21B 29/005; E21B 47/12

(57) ABSTRACT

An assembly, method and device are for performing a survey of tubing which is stuck in a borehole. The assembly has a tractor for advancing the assembly along the tubing on an inside thereof; at least one engager connected to the tractor, the engager being configured to couple the assembly to a wall of the tubing, such that a stimulus applied to the tubing, e.g. components of force or manipulation of the tubing, can be communicated to produce a response in a part of the assembly. A detector may detect the response when the assembly is coupled to the wall of the tubing, in order to produce data based on the response for determining a location at which the tubing may, or may not, be subjected to at least one operation for freeing the string or a portion thereof.

### TECHNICAL FIELD

The present invention relates to borehole operations, and in particular relates to a method of performing a survey of tubing which is stuck in a borehole, in particular for obtaining data for determining a location at which the string of tubing may, or may not be subjected to at least one operation for freeing the tubing or a portion thereof, and related apparatus, assembly, and device. The survey may allow data to be obtained to allow the location of a free point along the tubing to be found.

### BACKGROUND

In the oil and gas exploration and production industry, tubing of different kind may be employed in a borehole in the earth's subsurface for different purposes. In order to construct a well, tubulars may be connected together end-to-end to form a tubing string which may be provided with a bit at a penetrating end of the string for drilling out the rock in the subsurface of the earth to create a borehole. The string may be supported from a platform above the borehole and rotated in the borehole to turn the bit so that it cuts into the rock. As drilling progresses, new sections are typically added to the string and the string ex-tends from the platform and a substantial distance into the subsurface in the borehole. The tubing string may for instance comprise wellbore lining or casing, coiled tubing, or sections of drill pipe.

When inserting the tubing string into a borehole, e.g. by drilling, various obstacles in the borehole may be encountered which may hinder progress. A drill string may for example meet formations along the path into the well which are difficult to penetrate, or which may tend to collapse and generate large amounts of cuttings or debris which may clog the borehole and interfere with the drilling operation. In such situations, the tubing string in the borehole may become stuck in the wellbore, equipment may become damaged, and remedial action may be required. In general, the tubing in the wellbore may become stuck for a number of reasons, including for example differential pressure effects in the wellbore, key seating, sand bridging, wellbore collapse, and swelling of the wellbore. In wells which deviate from vertical toward a horizontal trajectory in far reaches of a borehole, gravity may pull the tubing toward a lower wall portion of the borehole creating increased friction on the string, and the risk of the tubing becoming struck may be exacerbated.

In the event of tubing that is stuck in the borehole, it may typically be sought to free the tubing from the borehole e.g. by trying to dislodge it. If this is not possible, it may be sought to disconnect from the portion of the string that has become struck in the borehole, before the borehole can be repaired and the process of inserting the tubing (e.g. drilling) may continue. After disconnection, the upper portion of the string may be freed up and pulled out of the borehole back to the surface. The disconnection may be performed by cutting the tubing string or unscrewing a joint between sections in the string at an appropriate point. An initial step is typically performed to identify whereabouts along the borehole the tubing string is stuck and/or where it is free (if it were to be disconnected). The so-called “free point” location along the tubing string may therefore be determined and the disconnection of the uphole portion of the string may be performed at the determined free point, or uphole from the free point, so that the upper portion of the string when disconnected will be free to be moved out of the wellbore.

In order to identify the free point, various techniques have been used. A common method is based on measuring the amount that a pipe twists or stretches when a particular torque or vertical force is applied to the string at or near the surface. In a long tubing string, the application of for example torque may be expected to produce some rotational twisting in the free part of the string, but a lack of movement or twisting where it is stuck.

A “free point” or “stuck point” tool may be employed for this purpose, and a wide range of such tools are known. Common free point tools are based on a mechanical connection to the tubing, and are inserted into position inside the string of tubing which has become stuck. Such tools may mechanically connect to the inner wall of the tubing through dedicated connecting members such as springs, magnets, or temporary anchors that extend from the tool to lock respective parts of the tool to the tubing. Relative movement of the string may then be transferred to the tool through the connecting members to produce a corresponding response in the form of relative movement in the tool, and a sensor in the tool may then typically detect the response. Where the sensor reveals no movement when torque or longitudinal force is applied, the tubing may be determined to be stuck at the location of the tool.

In order to determine the free point, free point tools are conventionally employed to survey the string stepwise in successive discrete locations along the tubing string until the free point is identified. They may be deployed with the connecting members for performing the measurement in retracted position. When in location, the connecting members may then be extended to lock onto the string. While conventional free point tools have generally gained acceptance as being successful in fulfilling their purpose, the inventors have recognised that it can still be quite time consuming using the conventional approaches to identify the free point, resulting in inconvenience and costs associated with downtime in the well construction process. Free point tools may also suffer from complexity and/or space constraints in the tool and in the provision of purpose built connecting members.

### SUMMARY OF THE INVENTION

It is an aim of the present invention to obviate or at least mitigate various drawbacks or difficulties associated with prior art techniques.

According to a first aspect of the invention, there is provided an assembly for performing a survey of tubing which is stuck in a borehole, the assembly comprising:
a tractor for advancing the assembly along the tubing on an inside thereof;
at least one engager connected to the tractor, the engager being configured to couple the assembly to a wall of the tubing, such that a stimulus applied to the tubing can be communicated to produce a response in a part of the assembly; and
a detector for detecting the response when the assembly is coupled to the wall of the tubing, in order to produce data based on the response for determining a location at which the tubing may, or may not, be subjected to at least one operation for freeing the string or a portion thereof.

The engager may comprise a wheel of the tractor. The engager may be mounted on an arm which may be configured to be operable to urge the engager to bear against an inner wall of the tubing, so as to couple the assembly to the wall of the tubing. The engager may be configured to couple the assembly to the wall while advancing along the tubing.

The assembly may further comprise: first and second parts connected and movable with respect to one another; at least one engager for coupling the first part of the assembly to a first wall portion of the tubing; and at least one engager for coupling the second part of the assembly to a second wall portion of the tubing. The engagers may be configured to couple the first and second parts of the assembly to the first and second wall portions of the tubing at respective locations on the string of tubing, such that a relative movement between said locations may produce the response for detection. The response may comprise a relative movement between the first and second parts of the assembly. The relative movement between the locations may result from the imparted stimulus.

The first and second parts of the assembly may be connected through a connection which may allow movement of the first part along the tubing relative to the second part along a longitudinal axis of the tubing in use, and the response may comprise a component of longitudinal movement along the axis. The first and second parts of the assembly may be connected through a connection which may allow rotational movement of the first part relative to the second part about a longitudinal axis of the tubing in use, and the response may comprise a component of rotational movement about the axis.

The engagers for coupling the first and second parts of the assembly to the first and second wall portions may both comprise a tractor wheel. The detector may comprise a strain gauge, accelerometer or the like, or any other suitable detector for detecting the response, e.g. a detector which may detect relative movements, strain, and/or stresses in the assembly.

The stimulus may comprise a component of applied force which may comprise any of: torque about a longitudinal axis of the tubing; longitudinal tension along the long axis of the string; and longitudinal compression along the long axis of the tubing. The stimulus may be generated by twisting, or compressing or extending a length of the tubing.

The assembly may further comprise an output for obtaining data from the detector, based on the detected response.

The assembly may further comprise communication means capable of transmitting produced data from the detector to the surface.

The assembly may further comprise at least one device for determining the position of the assembly or the position of the engagers along the tubing.

The assembly may further comprise a tubing joint locator for locating a joint between adjacent sections in the tubing.

The assembly may be a tool string. The assembly may be arranged to be deployed on a wireline.

The assembly may further comprise at least one tool for performing the operation for freeing the tubing or the portion thereof e.g., once the location at which the tubing is to be subjected to the operation has been determined. By freeing the tubing or portion thereof, the tubing or said portion may for instance pulled up hole. The tool for performing said operation may comprise a string shot tool for producing at least one shock wave at or near the determined location for facilitating to free the tubing.

The operation may be for example an operation for facilitating disconnection of a portion of string at the determined location. The tool for performing the operation may comprise a cutting tool for cutting the string of tubing at the determined location, wherein the determined location may be a location at which an up-hole portion of the tubing, based on the data, may be determined to be separable from a downhole portion of the tubing so as to be freed. The cutting tool may comprise a mechanical cutter device for penetrating into the wall of the tubing to cut the tubing.

The location at which the string of tubing may, or may not, be subjected to at least one operation for freeing the string or a portion thereof, may be a location at which a portion of the string of tubing may, or may not, be disconnected from said string and freed, e.g. the free point.

According to a second aspect of the invention, there is provided a method of performing a survey of tubing which is stuck in a borehole, the method comprising the steps of:
a. deploying an assembly as claimed in any preceding claim inside the tubing;
b. advancing the assembly along the tubing using the tractor;
c. applying a stimulus to the tubing, the assembly being coupled to the wall of the tubing by the engager, such that the stimulus can be communicated to produce a response in part of the assembly;
d. obtaining data dependent upon the response, using the detector; and
e. using the data to determine the location at which the tubing may, or may not, be subjected to at least one operation for freeing the string or a portion thereof.

The step of advancing the assembly may comprise moving the assembly along the tubing using the tractor, and during said movement, applying the stimulus to the tubing and detecting the response.

The method may further comprise processing the data to determine the location at which a portion of the tubing may, or may not, be disconnected and freed therefrom.

A first part of the assembly may be connected to a second part of the assembly so as to be movable relative to one another. Each of the first and second parts may be provided with at least one engager. The engager of the first part may be configured to couple between the first part and the wall of a first portion of the tubing. The engager of the second part being may be configured to couple between the second part and the wall of a second portion of the tubing. The response may comprise a relative movement between the first and second parts of the assembly. The data may be processed by removing or suppressing at least one noise component in the data.

The noise component obtained in the data may be associated with a change or fluctuation in force applied by the respective engagers against the wall of the first portion of the tubing and the wall of the second portions of the tubing during the advancement of the assembly.

The noise component obtained in the data may be associated with a change or fluctuation in speed of the engagers along the first and second portions of the tubing during the advancement of the assembly.

The noise component may comprise a high-frequency component and the method may further comprise low-pass filtering the data to remove the noise component.

The method may further comprise subtracting the noise component from the data.

The method may further comprise independently measuring a speed of travel of the first and second parts of the assembly during advancement through the borehole, and using the obtained speeds to determine the noise component.

The method may include obtaining at least one difference between the obtained speeds and using the obtained difference to determine the noise component.

The assembly may be advanced using the tractor to position the assembly in at least one location along tubing, and the method includes: pausing movement of the assembly in said location; and during the pause, applying the stimulus to the tubing and detecting the response.

A first part of the assembly may be connected to a second part of the assembly so as to be movable relative to one another. Each of the first and second parts of the assembly may be provided with at least one engager. The method may further comprise: positioning the assembly in at least one location along the tubing, such that the engager of the first part may couple between the first part of the assembly and a wall of a first portion of the tubing, and the engager of the second part may couple between the second part of the assembly and a wall of a second portion of the string of tubing. The response may comprise a component of relative movement between the first and second parts of the assembly. During the assembly being positioned in said position, the method may include applying the stimulus to the tubing and detecting the response.

The method may further comprise obtaining data from a tubing joint locator to determine the location of the assembly with respect to a joint in the tubing.

According to a third aspect of the invention, there is provided a method of performing a survey and freeing tubing or a portion thereof, said tubing or portion to be freed being stuck in a borehole, the method comprising the steps of:
(a) providing an assembly including a tractor and at least one tool inside the tubing;
(b) surveying the tubing by performing the method of the second aspect of the invention, comprising:
   i. advancing the assembly along the tubing;
   ii. applying a stimulus to the tubing, the assembly being coupled to the wall of the tubing by the engager; and
   iii. detecting a response of a part of the assembly to the applied stimulus, to determine the location at which the string of tubing is to be subjected to at least one operation so as to allow the string of tubing or a portion thereof to be freed;
(c) freeing the string of tubing or the portion thereof, using the tool at the identified location to perform said operation; and
(d) pulling the freed string or portion thereof along the borehole.

The method may further comprise disconnecting a portion of the string to be freed by cutting the string of tubing using a cutter.

According to a fourth aspect of the invention, there is provided a device for use in an assembly for performing a survey of a tubing which is stuck in a borehole, the assembly including a tractor, the assembly configured to be advanced along the tubing on an inside thereof by means of the tractor, the device comprising:
at least one engager configured to be connected to the tractor, the engager being further configured to couple the device to a wall of the tubing, such that a stimulus applied to the tubing can be communicated to produce a response in a part of the device or the assembly; and
a detector for detecting the response when the device is coupled to the wall of the tubing, in order to obtain data based on the response for determining a location at which the string of tubing may, or may not be subjected to at least one operation for freeing the tubing or a portion thereof.

According to a fifth aspect of the invention, there is provided apparatus including the assembly of the first aspect or the device of the fourth aspect. The apparatus may comprise a unit arranged at surface or topsides for receiving the data from the device and/or the assembly, which may be located inside the string of tubing when in use. The unit may be configured to process and/or analyse the received data for determining the location that at which an operation may or may not be performed to free the tubing or a portion thereof. The location may be a location at which a portion of tubing may be disconnected from the tubing and freed.

Any of the above aspects of the invention may include further features as described in relation to any other aspect, wherever described herein. Features described in one embodiment may be combined in other embodiments. For example, a selected feature from a first embodiment that is compatible with the arrangement in a second embodiment may be employed, e.g. as an additional, alternative or optional feature, e.g. inserted or ex-changed for a similar or like feature, in the second embodiment to perform (in the second embodiment) in the same or corresponding manner as it does in the first embodiment.

Various advantages of the invention and its features are described and will be apparent from the specification throughout.

### DESCRIPTION AND DRAWINGS

There will now be described, by way of example only, embodiments of the invention with reference to the accompanying drawings, in which:

FIG. 1 is a schematic representation of apparatus comprising an assembly being run inside a drill string which is stuck in a wellbore, according to an embodiment of the invention;

FIG. 2 is schematic representation of a tractor of the apparatus of FIG. 1 in close-up;

FIG. 3 is a schematic representation of the tractor when tensioning the drill string to determine a free point of the string; and

FIGS. 4A & 4B are graphs of amplitude versus time of recorded data, raw and filtered respectively, from a detector employed in the assembly of FIG. 1.

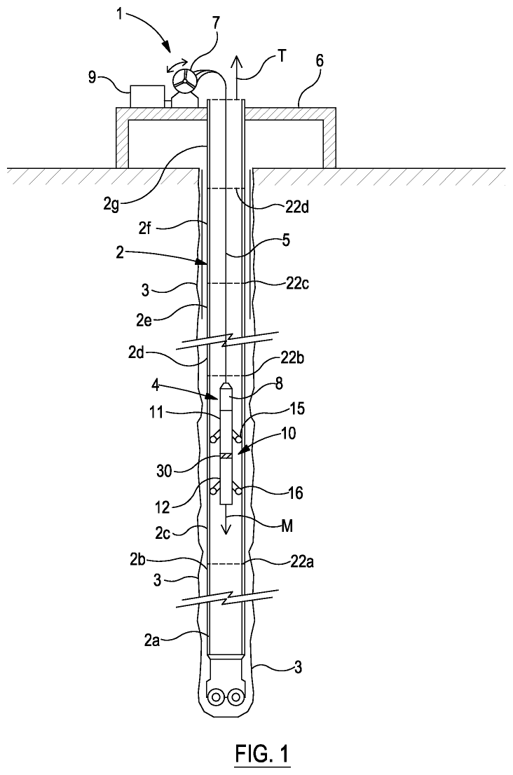

Turning first to FIG. 1, apparatus 1 for performing a survey and determining a free point location in a drill string 2 (a “tubing”) which is stuck in a wellbore 3 is depicted. The free point location constitutes a location at which a portion of the drill string may be disconnected from the tubing and freed.

The apparatus 1 comprises an assembly in the form of a tool string 4 deployed on a wireline 5 from a surface platform 6. The tool string 4 includes a wellbore tractor 10. The wireline 5 is spooled out from a drum 7 on the platform 6 as the tool string 4 progresses into the wellbore 3 along the inside of the drill string 2. The assembly is used for performing a survey of the drill string for determining the free point in the string 2. Communication of power and data is delivered through the wireline 5 between the tool string 4 and the surface. The data may include telemetry data for indicating the location of the tool string 4 in the wellbore 3. For example, the tool string 4 may include a tubing collar locator 8 for detecting joints between sections of the drill string 2, and data from the tubing collar locator 8 can be transmitted via the wireline 5 to the surface to a communication unit 9 on the platform 6. Based on the data from the tubing collar locator 8, the locations of the joints between sections of the drill string 2 can be found and the position of the tool string 4 along the drill string 2 or the wellbore 3 can thereby be obtained.

The drill string 2 is made up of multiple sections 2a-2g of drill pipe connected together end-to-end to form the string 2. The sections 2a-2g of drill pipe are screwed together, with joints being formed between adjacent sections as is per se conventional practice. A number of joints are therefore formed in the drill string 2, those illustrated in FIG. 1 being indicated by reference numerals 22a-22d.

The drill string 2 in the wellbore 3 has become stuck or jammed in place such that it is unable to be released by pushing, pulling, or turning the drill string by application of a giv-en force. The lower portion of the drill string 2, including for purposes of this example the sections 2a and 2b are held fast rigidly in place against the wall of the wellbore 3.

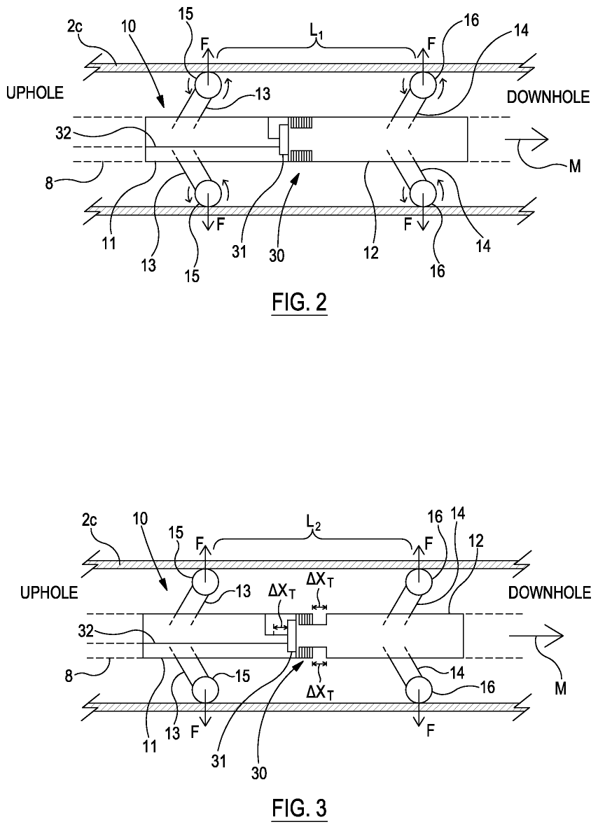

In order to determine the free point, the tractor 10 is utilised to survey the drill string, as is now described with further reference to FIGS. 2 and 3. First, it can be seen that the tractor 10 in this example has first and second parts 11, 12 (uphole and downhole respectively), which are connected together through a coupling 30. The first part 11 is provided with a first set of tractor wheels 15 and the second part 12 is provided with a second set of tractor wheels 16. The tractor wheels 15, 16 are driven by a motor to rotate and drive the tractor 10 along the drill string 2. The tractor wheels 15, 16 are each mounted on an arm which urges the wheel on the arm against and into contact with an inner wall of the drill string 2. A component of force F is applied via the wheels 15, 16 onto the wall so as to generate a strong frictional contact against the wall and so that the respective first and second parts 11, 12 of the tractor 10 are coupled to the drill string 2. The arms are depicted with reference numerals 13, 14, and are pivotally connected to respective parts 11, 12 of the body of the tractor 10 so that they can be moved away from the body to urge the wheels against the wall.

The force F may be generated in a great variety of ways. One way to generate the force F may be to apply hydraulic fluid to activate and urge the arms outwards. The hydraulic fluid could be pressurized from an electrical pump located in tractor 10. Energy to drive the pump may be supplied from the surface e.g. through the wireline. Electrical or mechanical mechanisms could also be used.

In FIGS. 1 to 3, the tractor 10 is positioned in a location along the section 2c of the drill string 2 with both the first and second sets of wheels 15, 16 coupled to the wall of the section 2c. The wheels are pressed firmly against the wall by the applied force F. The two sets of wheels 15, 16 are arranged longitudinally apart along the body of the tractor 10 so as to bridge a length of the section 2c.

The drill string 2 is pulled using equipment on the platform 6 such that a tension force T is applied to the drill string 2 from the platform 6. As a result of tensioning, the section 2c stretches longitudinally by an amount ΔX_{P} along the drill string 2. The locations on the wall at which the respective wheels 15 and 16 make contact are moved apart accordingly. The distance along the section 2c between respective wheels 15 and 16 increases from a length L1 (see FIG. 2) to a length L2 (see FIG. 3) by the amount ΔX_{P} (i.e. ΔX_{P}=L2−L1).

As can then be appreciated, due to the first and second parts 11, 12 of the tractor 10 being coupled through engagement of the wheels 15, 16 to the wall, the extension experienced in the drill string section 2c is transferred to the tractor 10.

More specifically, the coupling 30 between the parts 11, 12 allows for lengthways extension between the first and second parts 11, 12 of the tractor 10 corresponding to that of the drill string over the length bridged by the wheels 15 and 16. As seen in FIG. 3, when the tension T (a “stimulus”) is applied to the drill string 2, the first part 11 is extended with respect to the second part 12 by a distance ΔX_{T} which is equal to the extension ΔX_{P} of the pipe section 2c.

The fact that the tractor 10 responds to the extension in the tubing section 2c indicates that the pipe section 2c at or uphole of the location of the tractor 10 is not rigidly held in place in the wellbore 3 and would be free to move if it were to be disconnected from the drill string 2.

By moving the tractor 10 into different locations along the drill string 2, the drill string 2 can be surveyed using the tractor 10 in the manner described above to detect the movement (or not) in the drill string 2 in response to applied stimuli.

In this example, moving the tractor to a location of the drill string such as in the section 2b which is stuck, no extension between the first and second parts 11, 12 in the tractor 10 takes place when the drill string is tensioned. This indicates that the section 2b is rigidly stuck in place in the wellbore 3 and would not be removable. Although tension is applied to the drill string 2 at the surface, this does not result in extension or stretching of the section 2b of the drill string since section 2b is unable to extend, being rigidly stuck in place, in this case against the formation. It can then be determined for instance that the free point of the string 2 is uphole from the location of the tractor in section 2b, e.g. at or near the last known location in which a response was obtained by the tractor 10, e.g. in the section 2c in this example.

An operation may then be performed to free the tubing based on the free point determination. The drill string 2 may for example be cut or otherwise freed at the free point, e.g. at the joint 22a, to release the upper portion of the string 2 and allow it to be retrieved to the surface and removed from the wellbore 3. In other embodiments, explosives may be employed at or near the joint 22a to facilitate disconnection. To this end, the tool string 4 may include cutting tool or string shot tool or other tool for performing such an operation to facilitate freeing the drill string or uphole portion thereof.

Extension or stretching of the drill string 2 thus produces a response in the tractor in the form of relative movement between the first and second parts 11, 12. In the example of FIGS. 1 to 3, the tractor 10 has a detector in the form of a strain gauge 31 for detecting the movement between the first and second parts 11, 12. The strain gauge 31 is connected between the first and second parts 11, 12 so as produce data output corresponding to the amount of displacement ΔX_{T} therebetween. In the example, the strain gauge 31 is connected to an end of the second part 12 which is slidably inserted into an end of a housing of the first part 11, and also to the housing itself. In this way, the strain gauge 31 can detect the position or amount of movement between the housing of the first part and the inserted end of the second part for finding the amount of movement therebetween. Data from the strain gauge 31 is transmitted via a communication line 32 and the wireline 5 to the surface and is analysed. Other sensors for detecting the relative movements between the two interlinked parts could alternatively be used.

In using the tractor 10 in the technique above, the various sections 2a-2g of the drill string 2 may be progressively inspected as to whether a response is obtained indicative of the free point. The tractor 10 is moved into location within the relevant section in the drill string (with the first and second parts 11, 12 of the tractor 10 coupled to the wall of the drill pipe as described above) and tension is applied to the string. The tractor 10 may be stopped so that it is stationary when the tension is applied.

Alternatively, the tractor 10 can be moving when the tension is applied and the response is detected in the tractor. In other words, it may be applied while travelling under propulsion with the wheels turning and driving the tractor along drill string 2, as indicated by the arrow M in FIGS. 1 to 3. The tensioning of the drill string produces an extension in the coupling 30 while it is moving along the drill string 2. The casing collar locator 8 is typically used to help to identify the location of the tractor and/or that the tractor is appropriately positioned when applying the tension. Preferably, the tractor 2 is positioned at a location between joints when the stimulus is applied to the tubing and the response is detected, because in such locations a greater amount of extension may be observable over the length bridged by the wheels 15, 16, which may be more easily detected.

In the case of detecting the response while the tractor 10 (and tool string 4) is advancing along the drill string 2, a component of movement is associated with the overall propagation of the tool string 4 along the wellbore. When travelling with constant speed, the measurement of relative movement between the first and second parts 11, 12 of the tractor is unaffected. Alternatively, if the speed is not constant, the speed of the tractor or tools string 4 may be measured, so that any effects on the data from the strain gauge 31 due to the tool string or tractor accelerating or changes in speed can be corrected.

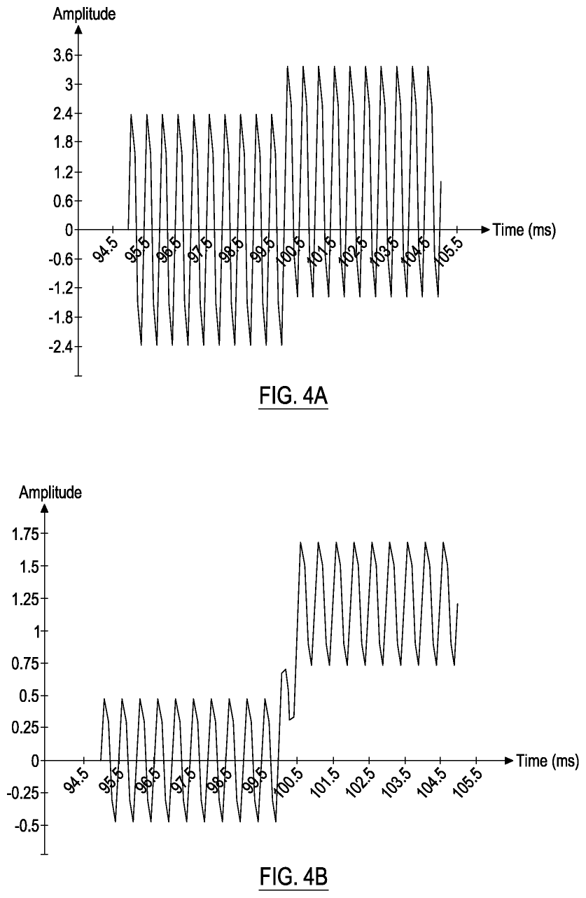

With further reference to FIGS. 4A and 4B, it can be appreciated that some amount of noise may be observed in the data obtained from the strain gauge 31 resulting from the operation of the tractor wheels 15, 16 as they bear against and turn on the wall of the drill string 2 while the measurement is made.

FIG. 4A is a graph of measured response data from the strain gauge (amplitudes against time) when applying the stimulus to the drill string and the tractor 10 is moving. The measured response data contains noise such that the signal due to applying the stimulus to the tubing is masked. FIG. 4B is a graph of the data of FIG. 4A after processing. The noise seen in FIG. 4A arises due to the turning of the tractor wheels 15, 16 which may result in some associated small relative movements between the first and second parts 11, 12 of the tractor 10 which may inadvertently be picked up by the strain gauge 31. The tractor wheels 15, 16 are geared so as to cooperate and turn at the same speed. Small fluctuations between turning speed of the two sets of wheels 15, 16 may lead to some noise. But in general, the first and second parts 11, 12 of the tractor 10 are held in constant relation to one another, apart from when they respond to a movement generated in the string 2 for finding the free point.

Noise in the data associated with wheels 15, 16 may have a particular frequency or signature, differing from that of the signal associated with movement of the pipe joint 22b, and such noise may be removed or separated from the signal by suitable processing such as filtering of the data, e.g. to remove the particular frequency component. In FIG. 4A, the wheel noise is a high-frequency component in the data, whereas the event associated with the stimulus and extension in the drill string is of low frequency. The high-frequency noise may in this case be removed from the data by low pass filtering the data as indicated by FIG. 4B. As seen in FIG. 4B, the signal due to the imparted stimulus can be better revealed as compared with FIG. 4A.

Although in the above, the drill string 2 is described as being tensioned and producing an axial movement of the joint 22b and extension in the coupling of the tractor 10, the drill string 2 could be manipulated from the platform 6 in other ways. For instance, a torque may be applied so that the drill string 2 above the free point twists in the wellbore 3. With the first and second parts 11, 12 of the tractor 10 being coupled to the drill string, a corresponding relative rotation in the coupling 30 may take place, which can be measured in a manner similar to that described above using the strain gauge 31. In other variants, both rotational twisting and tension of the string 2 may take place and be detected at the coupling 30 in the tractor via the strain gauge 31.

In the above, a vertical wellbore 3 is described, but in general the wellbore 3 could also be deviated away from vertical, and may be horizontal in far reaches of the wellbore 3, with a drill string or other kind of tubing string stuck therein.

The technique described can be advantageous in numerous ways. The tractor wheels 15, 16 can be utilised to provide anchoring of respective parts 11, 12 of the tractor 10 to the wall of the drill string 2. This can eliminate any need for dedicated connecting members such as employed in conventional tools, and the tractor wheels 15, 16 can remain in engagement as they turn. The tractor is operated to drive the tool string 4 through the inside of the drill string 2, and conveniently engages the sections of the drill string 2 to provide the necessary coupling without needing to retract and extract anchors during the process. The tractor 10 can simply be stopped or moved by driving the tractor wheels 15, 16 as required to position the tractor 10 in a survey location, in condition ready for determining the free point. The tool string 4 may conveniently include other tools such as for freeing the tubing, cutting the tubing, or performing repairs of the drill string 2 where a tractor 10 is often needed, e.g. particularly in highly-deviated wellbores. These other tools may be employed in a desired location in the tubing based on the determined free point. Thus, the free point may be determined and the cuts or repairs performed, in the same run. By use of the tractor 10, far reaches such as in near horizontal sections of a wellbore may be accessed, and in those reaches free points may be determined and remedial operations performed using the tool string 4. Accordingly, the present solution may allow the free point/stuck point to be determined with more accuracy and may allow the cuts to be performed further downhole in the wellbore, which may reduce the amount of tubing left in the well and facilitate subsequent operations or reduce losses in the event of any need to abandon the remaining stuck portion of the string in the borehole.

Various modifications and improvements may be made without departing from the scope of the invention which is described herein. It can be appreciated that the survey can be performed to determine a “stuck point” location instead of or in addition to determining the free point location. The stuck point location constitutes a location at which a portion of the drill string based on the data may not be disconnected feasibly and thus may not be freed.

1.-37. (canceled)

38. An assembly for performing a survey of tubing which is stuck in a borehole for determining a location at which the tubing may, or may not, be subjected to at least one operation for freeing the tubing or a portion thereof, the assembly comprising:
a tractor for advancing the assembly along the tubing on an inside thereof;
first and second parts and a connection connecting the first and second parts for allowing either or both longitudinal and rotational movement of the first part relative to the second part;
at least one tractor wheel connected to the first part, and at least one tractor wheel connected to the second part;
wherein in an operational configuration, the tractor wheels are arranged longitudinally apart for contacting respective locations on a wall of the tubing,
wherein the tractor wheels are operable to rotate and drive the assembly along the tubing when in contact with the wall,
wherein the tractor wheels are configured to couple between the wall and the respective first and second parts of the assembly when in contact with the wall, such that a stimulus applied to the tubing producing twisting and/or longitudinal compression or extension in a length of the tubing between the respective contact locations on the wall can be communicated to produce a response which comprises either or both of the longitudinal and the rotational relative movement between the first and second parts of the assembly; and
a detector for detecting the response, for producing data to determine the location at which the tubing may, or may not, be subjected to the operation for freeing the tubing or the portion thereof.

39. The assembly as claimed in claim 38, wherein the tractor wheel of either or both the first and second parts is mounted on an arm which is operable to urge the tractor wheel to bear against the wall of the tubing.

40. The assembly as claimed in claim 38, wherein the detector comprises a strain gauge.

41. The assembly as claimed in claim 38, further comprising an output for obtaining data from the detector, based on the detected response.

42. The assembly as claimed in claim 38, further comprising communication means capable of transmitting produced data from the detector to the surface.

43. The assembly as claimed in claim 38, further comprising at least one device for determining the position of the assembly or the position of the tractor wheels along the tubing.

44. The assembly as claimed in claim 38, further comprising a tubing joint locator for locating a joint between adjacent sections in the tubing.

45. The assembly as claimed in claim 38 being a tool string.

46. The assembly as claimed in claim 38 arranged to be deployed on a wireline.

47. The assembly as claimed in claim 38, which further comprises at least one tool for performing the operation for freeing the tubing or the portion thereof once the location at which the tubing is to be subjected to the operation has been determined.

48. The assembly as claimed in claim 47, wherein the tool for performing said operation comprises a string shot tool for producing at least one shock wave at or near the determined location for facilitating to free the tubing.

49. The assembly as claimed in claim 48, wherein the tool for performing the operation comprises a cutting tool for cutting the string of tubing at the determined location, wherein the determined location is a location at which an up-hole portion of the tubing, based on the data, is determined to be separable from a downhole portion of the tubing so as to be freed.

50. The assembly as claimed in claim 49, wherein the cutting tool comprises a mechanical cutter device for penetrating into the wall of the tubing to cut the tubing.

51. A method of performing a survey of tubing which is stuck in a borehole, the method comprising the steps of:
a. deploying an assembly including a tractor inside the tubing, the assembly having first and second parts that are connected through a connection that allows either or both longitudinal and rotational movement of the first part relative to the second part, wherein at least one tractor wheel is connected to the first part, and at least one tractor wheel is connected to the second part, the tractor wheels being arranged longitudinally apart and in contact against a wall of the tubing;
b. advancing the assembly along the tubing using the tractor;
c. applying a stimulus comprising a component of force to the tubing, the component of force comprising any one or more of:
torque about a longitudinal axis of the tubing;
tension along the longitudinal axis; and
compression along the longitudinal axis;
the assembly being coupled to the wall of the tubing by the tractor wheels, twisting and/or longitudinal compression or extension produced in a length of the tubing between the locations of contact of the tractor wheels on the wall producing a response which comprises either or both of said longitudinal and said rotational relative movement between the first and second parts of the tractor;
d. detecting the response, obtaining data dependent upon the response; and
e. using the data to determine the location at which the tubing may, or may not, be subjected to at least one operation for freeing the tubing or a portion thereof.

52. The method as claimed in claim 51, wherein the step of advancing the assembly comprises moving the assembly along the tubing using the tractor, and during said movement, applying the stimulus to the tubing and detecting the response.

53. The method as claimed in claim 52, which further comprises processing the data to determine the location at which a portion of the tubing may, or may not, be disconnected and freed therefrom.

54. The method as claimed in claim 53, wherein the data are processed by removing or suppressing at least one noise component in the data.

55. The method as claimed in claim 54, wherein the noise component obtained in the data is associated with a change or fluctuation in force applied by the respective tractor wheels against the wall of the first portion of the tubing and the wall of the second portion of the tubing during the advancement of the assembly.

56. The method as claimed in claim 55, wherein the noise component obtained in the data is associated with a change or fluctuation in speed of the tractor wheels along the first and second portions of the tubing during the advancement of the assembly.

57. The method as claimed in claim 54, wherein the noise component comprises a high-frequency component and the method further comprises low-pass filtering the data to remove the noise component.

58. The method as claimed in claim 53, which further comprises subtracting the noise component from the data.

59. The method as claimed in claim 53, which further comprises independently measuring a speed of travel of the first and second parts of the assembly during advancement through the borehole, and using the obtained speeds to determine the noise component.

60. The method as claimed in claim 59, which includes obtaining at least one difference between the obtained speeds and using the obtained difference to determine the noise component.

61. The method as claimed in claim 50, wherein the assembly is advanced using the tractor to position the assembly in at least one location along the tubing, and the method further includes: pausing movement of the assembly in said location; and during the pause, applying the stimulus to the tubing and detecting the response.

62. The method as claimed in claim 50, which further comprises:
positioning the assembly in at least one location along the tubing; and
during the assembly being positioned in said position, applying the stimulus to the string of tubing and detecting the response.

63. The method as claimed in claim 62, which further comprises obtaining data from a tubing joint locator to determine the location of the assembly with respect to a joint in the tubing.

64. A method of performing a survey and freeing tubing or a portion thereof, said tubing or portion to be freed being stuck in a borehole, the method comprising the steps of:
(a) providing an assembly including a tractor and at least one tool inside the tubing;
(b) surveying the tubing by:
i. advancing the assembly along the tubing;
ii. applying the stimulus to the tubing, the assembly being coupled to the wall of the tubing by the tractor wheels; and
iii. detecting the response comprising either or both longitudinal and rotational relative movement between the first and second parts of the tractor, to determine the location at which the tubing is to be subjected to at least one operation so as to allow the tubing or a portion thereof to be freed;
(c) freeing the tubing or the portion thereof, using the tool at the identified location to perform said operation; and
(d) pulling the freed tubing or portion thereof along the borehole.

65. The method as claimed in claim 64, which further comprises disconnecting a portion of the tubing to be freed by cutting the tubing using a cutter.

66. A tractor for use in an assembly for performing a survey of a tubing which is stuck in a borehole, the assembly configured to be advanced along the tubing on an inside thereof by means of the tractor, the tractor comprising:
first and second parts and a connection connecting the first and second parts for allowing either or both longitudinal and rotational movement of the first part relative to the second part;
at least one tractor wheel connected to the first part, and at least one tractor wheel connected to the second part;
wherein in an operational configuration, the tractor wheels are arranged longitudinally apart for contacting respective locations on a wall of the tubing,
wherein the tractor wheels are configured to couple between the wall and the respective first and second parts of the assembly when in contact with the wall, such that a stimulus applied to the tubing producing twisting and/or longitudinal compression or extension in a length of the tubing between the respective contact locations on the wall can be communicated to produce a response comprising either or both the longitudinal and the rotational relative movement between the first and second parts of the tractor; and
a detector for detecting the response for obtaining data to determine the location at which the string of tubing may, or may not be subjected to at least one operation for freeing the tubing or a portion thereof.
